(19) United States
(12) Patent Application Publication
(10) Pub. No.: US 2023/0048927 A1
(43) Pub. Date: Feb. 16, 2023

(54) LIQUID WASTE CONTAINER

(71) Applicant: Hewlett-Packard Development Company, L.P., Spring, TX (US)

(72) Inventors: Cesar Luis Coelho Morais de Serpa Rosa, Sant Cugat del Valles (ES); Marc Clotet Marti, Sant Cugat del Valles (ES); Alberto Borrego Lebrato, Sant Cugat del Valles (ES)

(21) Appl. No.: 17/793,895

(22) PCT Filed: Jan. 30, 2020
(86) PCT No.: PCT/US2020/015848

§ 371 Date: Jul. 19, 2022

(51) Int. Cl. B41F 31/20

(52) U.S. Cl. CPC B41F 31/20

(57) ABSTRACT

Certain examples described herein relate to liquid waste containers delimiting an opening for receiving liquid. The liquid waste container comprises a receptacle for liquid waste and a bistable arrangement having first and second stable states such that when the bistable arrangement is in the first stable state, liquid can be received into the receptacle through the opening, and when the bistable arrangement is in the second stable state, liquid is prevented from exiting the receptacle through the opening. The example liquid waste container further comprises an actuator arranged to engage the bistable arrangement and to cause the bistable arrangement to transition from the first stable state to the second stable state.

### BACKGROUND

Liquid waste is a common byproduct of various systems. For example, during certain procedures, printing systems may deposit print fluid, but do not apply the print fluid to a print target, such as paper. In such cases, the print fluid may be captured and contained in a liquid waste container that may be removably connected to the printing system.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1a is a cross-sectional schematic view of a liquid waste container according to a first example wherein the liquid waste is at a first level.

FIG. 1b is a close-up of a bistable arrangement when an actuator begins to engage the bistable arrangement.

FIG. 1c is a cross-sectional schematic view of the liquid waste container according to the first example wherein the liquid waste is at a second level.

FIG. 1d is a cross-sectional schematic view of the liquid waste container according to the first example, inverted.

FIG. 2 is a cross-sectional schematic view of a liquid waste container according to a second example.

FIG. 3 is a cross-sectional schematic view of the liquid waste container according to a third example.

FIG. 4 is a cross-sectional schematic view of a liquid waste container according to a fourth example.

FIG. 5 is a schematic diagram of a printing system according to an example.

### DETAILED DESCRIPTION

Certain examples described herein relate to a liquid waste container, or reservoir, that delimits an opening and comprises a receptacle, a bistable arrangement and an actuator. The bistable arrangement has a first stable state and a second stable state, and is arranged such that: when the bistable arrangement is in the first stable state, liquid can be received into the receptacle through the opening; and when the bistable arrangement is in the second stable state, liquid is prevented from exiting the receptacle through the opening. The actuator is arranged to engage with the bistable arrangement to cause the bistable arrangement to transition from the first stable state to the second stable state.

In general, a bistable system is any system that comprises at least two stable equilibrium states. The system can be caused to transition between the at least two stable equilibrium states through an application of an external force, while in an absence of any applied forces, the system remains in its current stable equilibrium state. Thus, a “bistable” as used herein includes systems having two states and systems having three, four or more stable states.

Such a bistable system can be implemented in a liquid-tight sealing mechanism in a liquid waste container. For example, the bistable system can be arranged to allow liquid waste to be received within a receptacle of the liquid waste container when in the first stable state, and can be arranged to prevent liquid waste from being received within, or allow liquid waste to exit, through the receptacle when in the second stable state. The bistable system can be caused to transition between the first and second stable states through an application of an external force provided by an actuator. In some examples, the actuator applies a force to the bistable system when a predetermined condition is met, such as when the liquid waste within the receptacle reaches a predetermined level. In other examples, the actuator applies a force to the bistable system in response to input, such as when a button of the liquid waste container is pressed.

The bistable system can be transitioned back to the first stable state through an application of an additional force. For example, the bistable system may be positioned within the liquid waste container so that it is accessible to allow a force to be applied which causes the transition from the second stable state to the first stable state. This means that leakage of liquid waste is reduced when the liquid waste container is tilted, handled and inverted because the bistable system will tend to remain in the second closed position unless an additional force is applied.

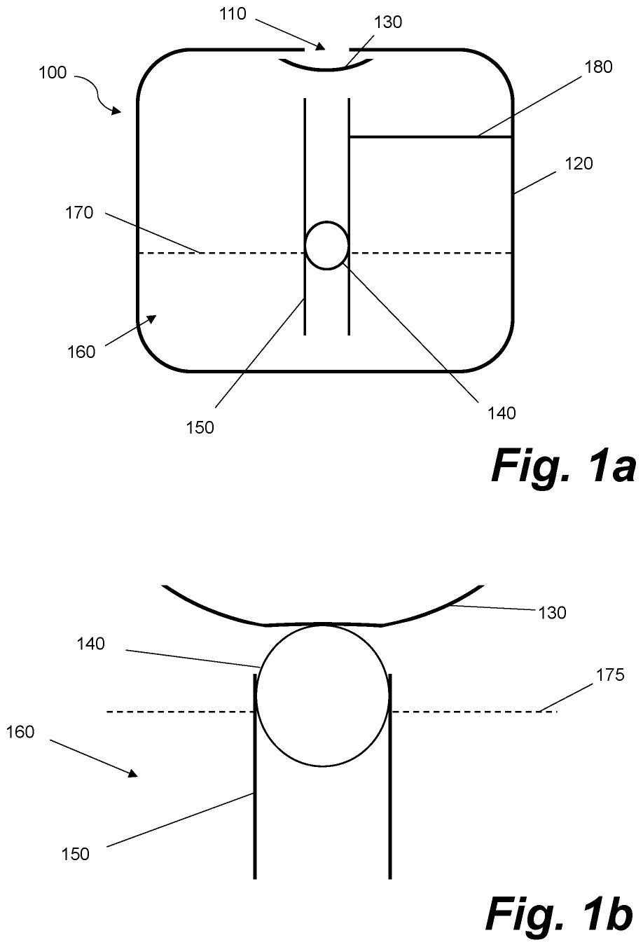

FIG. 1a shows a schematic representation of a cross section of a liquid waste container 100 according to a first example. The example liquid waste container 100 delimits an opening, or aperture, 110 and comprises: a receptacle 120, a spring membrane 130, an internal float 140, and a guiding arrangement 150.

The spring membrane 130 has a unitary construction and comprises a closed surface that forms a boundary separating upper and lower sides of the spring membrane 130. As depicted in cross section in FIG. 1a, the spring membrane 130 takes the form of a spherical cap and may be made from any suitable material that is capable of undergoing elastic deformation, such as silicone rubber. In a first stable state, at least a portion of the spring membrane 130 curves downwards, towards the base of the receptacle 120. In this state, the spring membrane 130 does not form a seal around the opening 110, because there is a space between the spring membrane 130 and the opening 110. Liquid waste can therefore be received into, and can exit, the receptacle 120 via the opening 110 when the spring membrane 130 is in the first state.

The internal float 140 is arranged to float over liquid waste 160 inside the receptacle 120 and therefore follows a liquid waste level within the receptacle 120 (from now on referred to as the ‘liquid level’), as it varies. In this example, the internal float 140 is a hollow sphere, but other shapes can also be used.

The guiding arrangement 150 constrains the internal float 140 to move along a reversible path as the liquid level 170 varies. The internal float 140 is constrained to move between a first position, located within the receptacle 120, and a second position located in proximity of the bistable arrangement such that the internal float 140 engages with the bistable arrangement when at the second position. More specifically, in this example, the guiding arrangement 150 is a hollow tube positioned inside the receptacle 120. To allow liquid to enter and leave the guiding arrangement so that the internal float 140 tracks the liquid level, the hollow tube has gaps at each end with the receptacle 120, so that both ends of the tube are open. The hollow tube is be attached to an internal side wall of the receptacle by a support member 180 to fix its position within the receptacle 120.

In use, as liquid waste enters the receptacle 120, the liquid level 170 rises. Consequently, the internal float 140 moves with the rising liquid level in a direction defined by the guiding assembly 150. At some point, the liquid level 170 will reach the predetermined level at which the internal float 140 will begin to engage with the spring membrane 130.

FIG. 1b shows a detail schematic view of the spring membrane 130 of the liquid waste container 100 depicted in FIG. 1a when the internal float 140 engages the spring membrane 130. As the internal float 140 engages the spring membrane 130, a small upward force is applied to the spring membrane 130 by the internal float 140. The spring membrane 130 will, as a consequence of the upward force, deform slightly and exert a balancing force on the internal float 140. As the liquid level 175 rises, the spring membrane constrains the internal float 140 from rising at the same rate as the liquid. An upthrust force exerted by the liquid on the internal float 140 increases, and therefore the balancing deflection force exerted by the spring membrane increases. The spring membrane 130 has a maximum possible deflection force that it can exert which is dependent on the type of material the spring membrane 130 is made from, and its dimensions. When the upthrust force becomes larger than this maximum possible deflection force of the spring membrane 130, the spring membrane 130 suddenly flips upwards into a second stable state.

FIG. 1c is a schematic cross-sectional view of the liquid waste container 100 depicted in FIG. 1a, when the liquid level 170 has exceeded the predetermined level, the internal float 140 has engaged the spring membrane 130, applied an upward force to the spring membrane 130 and caused it to transition to the second stable state. In the second stable state, at least a portion of the spring membrane 130 curves away from the base of the receptacle 120. The spring membrane 130 has transitioned into the second stable state where it is in contact with the opening 110 and forms a seal around an edge of the opening 110. Liquid waste is therefore prevented from being received into, or exiting from, the liquid waste container 100 through the opening 110 when the spring membrane 130 is in the second stable state.

In some examples, the bistable arrangement, or construction, can be transitioned from the second stable state to the first stable state by an application of an external force to the bistable arrangement. This property allows the liquid waste container 100 to be emptied of its contents. In the example liquid waste container 100 depicted in FIGS. 1a and 1c, the spring membrane 130 can be transitioned from the second stable state to the first stable state by physically pressing on the spring membrane 130 in the direction into the container, thereby causing it to move into the first stable state. Moving the bistable arrangement into the first stable state unseals the opening 110 and allows the contents of the liquid waste container 100 to be emptied in a controlled manner.

In some examples, when the liquid waste container 100 is inverted while the bistable arrangement is in the second stable state, the bistable arrangement remains in the second stable state reducing the risk of leakage. This property can be seen in FIG. 1d which shows a cross-sectional view of the example liquid waste container 100 of FIG. 1c, inverted. When inverted, the internal float 140 follows the liquid level 195, thereby moving away from the spring membrane 130. Although the float no longer acts on the spring membrane 130, a weight of a column of liquid directly above the spring membrane 130 pushes against the spring member, actually increasing the seal formed by the spring membrane 130 around the opening 110 because of the curvature of the membrane in the second state, further reducing the risk of leakage when inverted. This means that the spring membrane 130 stays in the second stable state when inverted and the seal is actually increased when the liquid waste container 100 is inverted.

When the bistable arrangement is in the first stable state, as depicted in FIG. 1a, inversion of the liquid waste container 100 will cause the bistable arrangement to transition from the first stable state to the second stable state. This closes the opening 110 and reduces the risk of accidental leakage by inversion. This can be understood by referring to the inverted orientation of the liquid waste container 100 as depicted in FIG. 1d. After inversion, a weight of a column of liquid directly above the spring membrane 130 may provide at least enough force needed to cause a transition of the bistable arrangement from the first stable state to the second stable state, depending on the amount of liquid within the receptacle 120. Therefore, if the liquid waste container 100 is removed from the system before the spring membrane 130 has transitioned to the second stable state, inverting the liquid waste container 100 will cause the spring membrane 130 to transition to the first stable state, closing off the opening 110 and reducing the risk of leakage.

As discussed above, in an example the guiding arrangement 150 is a hollow tube with both ends spaced from the receptacle 120. Other forms of guiding arrangement may be used. In another example the guiding assembly 150 extends from a base of the receptacle 120 to the second point in proximity with the bistable arrangement. In this case, the hollow tube may comprise openings in its sides such that liquid may flow into and out of the hollow tube. In other examples, the guiding arrangement 150 may comprise at least three rod-like members arranged to surround the internal float 140 such that the rod-like members act as a track for the internal float 140 to travel along as the liquid level 170 varies. In any case, the guiding arrangement 150 is arranged such that, at hydrostatic equilibrium within the receptacle 120, the liquid waste level inside the guiding arrangement 150 is equal to the liquid waste level outside the guiding arrangement 150. This allows the internal float 140 to move with the liquid level 170.

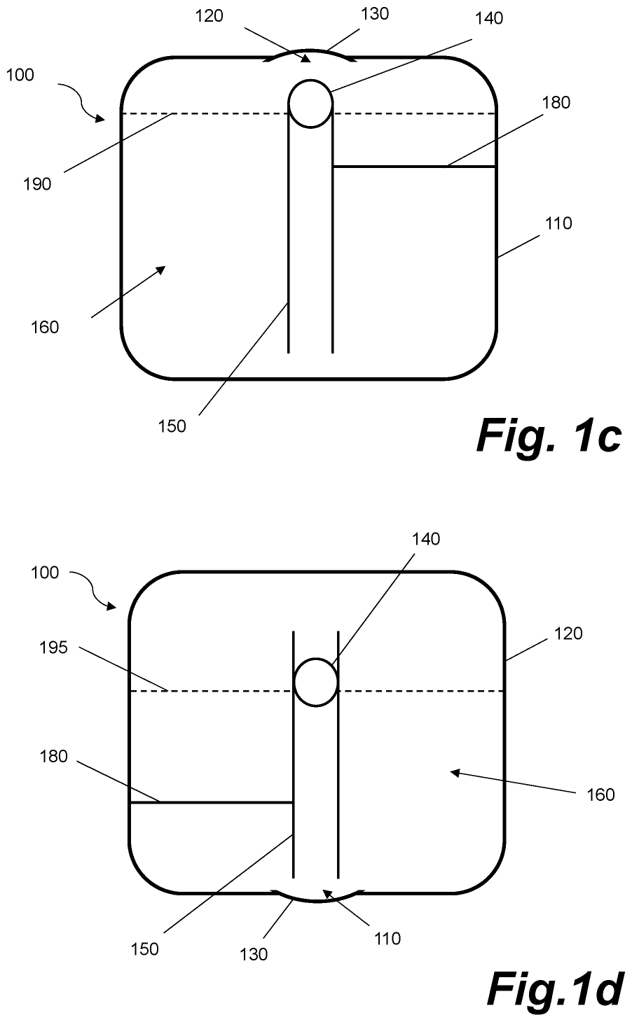

FIG. 2 is a cross-sectional view of a liquid waste container 200 according to a second example. The liquid waste container 200 has a similar arrangement as the example liquid waste container 100 depicted in FIG. 1a. In the example of FIG. 2, the actuator comprises an internal float 240 attached to a first end of an elongate member 250. A second end of the elongate member 250 is attached to an internal wall of the receptacle 220 via a hinge. This allows the elongate member 250 to pivot within the receptacle 220, thereby constraining the internal float 240 to move along an arc 280.

The operation of the actuator in this example is similar to the operation of the internal float 140 and guiding arrangement 150 of the liquid waste container 100. Initially, the liquid level 270 may be below the predetermined level. As liquid waste is added to the receptacle 220 through an opening 210, the liquid level 270 rises. Due to buoyancy, the internal float 240 moves with the rising liquid level 270. The internal float 240 thereby traces out the arc 280 defined by the elongate member 250 as it pivots within the receptacle 220. When the liquid level 270 reaches the predetermined level, the internal float 240 engages with a spring membrane 230, causing it to transition from the first stable state to the second stable state in a similar manner as explained above with reference to FIG. 1b.

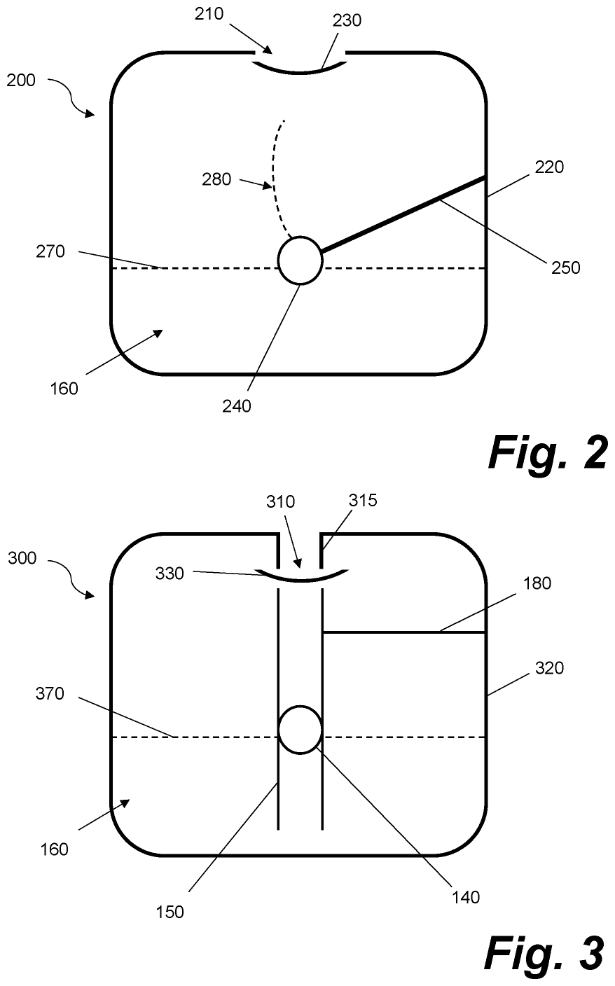

FIG. 3 is a cross-sectional view of a liquid waste container 300 according to another example. The liquid waste container 300 is the same as the liquid waste container 100, but the opening 310 of the liquid waste container 300 is positioned within the receptacle 320 and connected to a surface of the liquid waste container 300 via a channel 315. This is useful for when liquid waste continues to be dispensed towards the opening 310 after the liquid waste container 300 is sealed by the operation of the actuator. For example, it may not be possible to stop the flow of liquid waste immediately when the actuator causes the spring membrane 330 to transition to the second state. In this case, any additional liquid waste that is dispensed towards the opening 310 will collect in the channel 315 of the liquid waste container 300. This reduces additional mess that may result from the deposition of additional liquid waste once the liquid level 370 has reached the predetermined level and the liquid waste container 300 is sealed.

The example liquid waste containers 100, 200, 300 above comprise an automatic sealing mechanism that does not need intervention from a user. Once the liquid level 170, 270, 370 reaches a predetermined level, the bistable arrangement transitions to a second stable state, thus sealing the liquid waste container 100, 200, 300. However, in some cases, it may be useful to provide a sealing mechanism that is manually operated so that sealing of the liquid waste container 100, 200 may be controlled. That is, the transition of the bistable arrangement from the first stable state to the second stable state may be manually operated. This is of use when the liquid waste container is removed from the system before the liquid reaches a predetermined level, such as when a regular maintenance process is carried out to remove, empty and/or replace the liquid waste container.

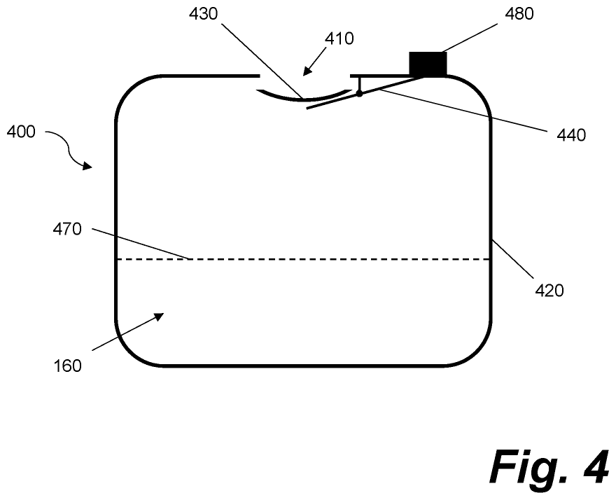

FIG. 4 is a cross-sectional view of a further example of a liquid waste container 400. In the example of FIG. 4, the actuator comprises a button 480 which, when pressed, causes a spring membrane 430 to transition from a first stable state to a second stable state.

The button 480 acts on a first end of a lever 440. A second end of the lever is positioned near the bistable arrangement and the fulcrum of the lever 440 is positioned at a point between the first and second ends and attached to, and spaced from, an upper internal wall of the receptacle 420 via an elongate member. When the button is pressed, the first end of the lever 440 is pushed downwards into the receptacle 420, pivoting the second end of the lever upwards, towards the opening 410.

When the button 480 is pushed down by a predetermined distance, the second end of lever 440 is arranged to engage with the spring membrane 430. As the button 480 is further pressed down, the second end of the lever 440 is further pressed into the spring membrane 430. At some point, the leverage force provided by pressing the button 480 overcomes the maximum balancing deflection force of the spring membrane 430 causing it to transition from the first stable state to the second stable state. The fulcrum can be positioned closer to the second end of the lever 440 than the first end so that the force needed to be applied to the button 480 to cause the transition can be adjusted. For example, a relatively high force can be useful to avoid accidental closure, while a relatively low force can be useful to make it easier to close the opening 410. Other examples of button activated mechanisms are possible.

Further implementations are possible. For example, any of the button mechanisms of FIG. 4 may be implemented alongside the internal float examples depicted in FIGS. 1a-3 so that the transition to the second state is both automatic and manual.

Although the example liquid waste containers 100, 200, 300, 400 described above comprise specific examples of bistable arrangements and actuators, alternatives of each are possible. For example, the bistable arrangement, or construction, may comprise any arrangement comprising two stable states. Examples of such bistable arrangements include center-offset springs and cam mechanisms.

Also, the actuator may differ from the example implementations described above. The actuator can be any arrangement that engages with the bistable arrangement to cause it to transition from the first stable state to the second stable state. The type of actuator implemented may depend on the specific bistable arrangement used. In some examples, the actuator may cause the bistable arrangement to transition to the second stable state when the liquid level 170, 270, 370 reaches a predetermined level. Alternatively, the actuator may comprise any mechanism that causes the bistable arrangement to transition to the second stable state when a button is pressed.

The above described liquid waste containers can be used in various domestic, commercial and industrial systems that output liquid waste that needs to be captured and stored. An example is a printing device wherein waste print fluid is not applied to a printing substrate and so needs to be captured and contained.

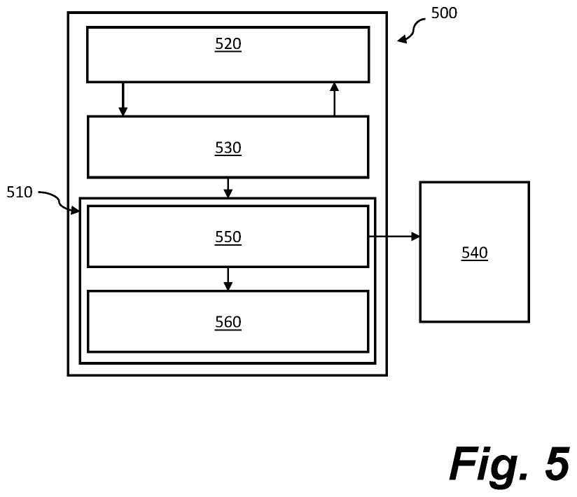

FIG. 5 shows a schematic diagram of a printing system 500 according to an example. Certain examples of liquid reservoirs described herein are implemented within the context of this printing system. The printing system 500 may be a 2D printer such as an inkjet or digital offset printer. In the example of FIG. 5, the printing system 500 comprises a printing device 510, a memory 520 and a processor 530. The processor 530 may implement machine readable instructions and/or be suitably programmed or arranged hardware.

The printing device 510 comprises a source of print fluid 550, and is arranged to apply print fluid to a print target in a printing process, to produce a print output 540. The print output 540 may, for example, comprise print fluid deposited on a substrate. The printing device 510 may comprise an inkjet deposit mechanism which may, for example, comprise a nozzle to deposit the print fluid. The inkjet deposit mechanism may include circuitry to receive instructions associated with depositing print fluid. The printing device 510 may comprise a multi-level drop-weight print device. A multi-level drop-weight printing device is a printing device that is arranged to deposit print fluids with more than one possible drop-weight. The substrate may be paper, fabric, plastic or any other suitable print medium.

In some examples, a process may comprise a printing device maintenance procedure. This may be to assess the performance of a particular component of the printing device 510, to analyze the efficiency of the printing device 510 to a particular printing process, or to improve the quality of printing such as by cleaning print heads. The automatic maintenance procedure may involve wiping, spitting or purging of print fluid. In such cases, print fluid from the source of print fluid 550 may be deposited by the nozzle, but not applied to a substrate because such procedures are generally carried out without a substrate in place. To prevent damage to the printing device 510 or leakage from the printing device 510 occurring, the print fluid may be captured and contained in a liquid reservoir 560 delimiting an aperture for receiving the print fluid into the reservoir, and which is positioned underneath a print head nozzle.

The printing device 510 also comprises a bistable construction and an actuator. The bistable construction is movable between a first stable state and a second stable state, and positioned such that in the first stable state the aperture of the liquid reservoir 560 is open, and in the second stable state the aperture is closed. The actuator is arranged to engage the bistable construction and cause the bistable construction to move from the first stable state to the second stable state as described above with reference to the examples shown in FIGS. 1-4.

In some cases, the liquid reservoir 560 is reusable so that the liquid reservoir 560 is removed from the printing device 510, emptied of its contents, and reinserted back into the printing device 510 for further use. In other cases, the liquid reservoir 560 may be disposable.

The above described liquid reservoir 100-400 provides an effective apparatus for capturing and containing waste print fluid output from a printing device during maintenance procedures. The liquid reservoir has reduced leakage while the bistable construction is in the second state. In some examples, when the liquid reservoir is inverted, the seal formed by the bistable construction is increased by the downward force of the weight of the liquid within the liquid reservoir. In some examples, when the liquid reservoir is removed from the printing device while the bistable construction is in a first stable state, an inversion of the liquid reservoir will provide the force needed to cause the bistable construction to transition to the second stable state and thereby seal the liquid reservoir, further reducing leakage.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

1. A liquid waste container delimiting an opening for receiving liquid waste through the opening into a receptacle and comprising:
a bistable arrangement having a first stable state and a second stable state, wherein:
when the bistable arrangement is in the first stable state, liquid can enter the receptacle through the opening; and
when the bistable arrangement is in the second stable state, liquid is prevented from entering the receptacle through the opening; and
an actuator to engage the bistable arrangement and to cause the bistable arrangement to transition from the first stable state to the second stable state.

2. The liquid waste container of claim 1, wherein the bistable arrangement is caused to transition from the first stable state to the second stable state by a force acting in a direction from the receptacle to the opening.

3. The liquid waste container of claim 1, wherein inversion of the liquid waste container while the bistable arrangement is in the first stable state causes the bistable arrangement to transition from the first stable state to the second stable state.

4. The liquid waste container of claim 1, wherein the actuator comprises an internal float constrained to travel along a pre-defined path within the receptacle, and is arranged to cause the bistable arrangement to transition from the first stable state to the second stable state when a liquid level inside the receptacle reaches a predetermined level.

5. The liquid waste container of claim 4, wherein the internal float is constrained by a guiding member within the receptacle.

6. The liquid waste container of claim 4, wherein the internal float is attached to an elongate member arranged to pivot within the receptacle, thereby constraining the internal float.

7. The liquid waste container of claim 1, wherein the actuator comprises a switch to cause the bistable arrangement to move from the first stable state to the second stable state.

8. The liquid waste container of claim 1, wherein the bistable arrangement comprises a cam mechanism, center-offset spring or a spring membrane.

9. The liquid waste container of claim 1, wherein the opening is positioned within the receptacle and is connected to a surface of the liquid waste container via a channel.

10. The liquid waste container of claim 1, wherein the bistable arrangement can be transitioned from the second stable state to the first stable state by applying an external force to the bistable arrangement.

11. A printing device comprising:
a source of print fluid;
a liquid reservoir delimiting an aperture, the aperture for receiving the print fluid into the reservoir;
a bistable construction movable between a first stable state and a second stable state, and positioned such that:
in the first stable state the aperture is open; and
in the second stable state the aperture is closed; and
an actuator to engage the bistable construction and to cause the bistable construction to move from the first stable state to the second stable state.

12. The printing device of claim 11, wherein the liquid reservoir is a removable component of the printing device.

13. The printing device of claim 11, wherein, in use, the liquid reservoir is arranged to receive printing fluid from the source of print fluid.
